(19) United States
(12) Patent Application Publication
(10) Pub. No.: US 2008/0221885 A1
(43) Pub. Date: Sep. 11, 2008

(54) Speech Control Apparatus and Method

(75) Inventor: Chi-Yang Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Arachnoid Biometrics Identification Group Corp, Taipei (TW)

(21) Appl. No.: 11/765,095

(22) Filed: Jun. 19, 2007

(30) Foreign Application Priority Data
Mar. 9, 2007 (TW) 96108230

(51) Int. Cl. G10L 17/00

(52) U.S. Cl. 704/246; 704/E17.003

(57) ABSTRACT

A speech control apparatus and a method thereof are provided. The speech control apparatus logs the user in an application software according to a speech signal of a user. The speech control apparatus is connected to a password bank comprising a plurality of accounts and passwords. The speech control apparatus comprises a speech process module, a start module, a first receive module, an identity recognition module, a selection module, and a login module. The speech process module determines a meaning of the speech signal. The start module starts the application software according to the meaning of the speech signal. The first receiving module receives the biometrics feature of the user. The identity recognition module identifies the user as authorized according to the biometrics feature. The selection module selects a login set of account and password from the password bank according to the speech signal and the biometrics feature. The login module logs the user into the application software according to the login set of account and password.

This application claims priority to Taiwan patent application No. 096108230 filed on 9 Mar. 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a speech control apparatus and a method thereof. The present invention especially relates to a speech control apparatus and a method thereof for logging in an application software according to a speech signal of a user.

2. Descriptions of the Related Art

With the increasing use of computers, various application softwares (such as mail softwares, instant message softwares, and network banks) have been developed to increase the user's convenience. In order to let different users to use an application software, a user intends to use the application software is required to enter an account and a password. After the entered account and the password are recognized, the user can then use the application software.

Since different application softwares have different rules on account and password, users have to remember several sets of password and account corresponding to different application softwares. With so many sets of account and password, it is inconvenient for the user to remember this much detail. Furthermore, manually inputting these sets of account and password is time-consuming and inconvenient as well.

In recent years, biometric techniques have been developed to enhance security. These techniques consider the biometric features (such as fingerprints, voiceprints and irises) of humans as the identification for users. This feature is based on the idea that the biometric features of each individual are unique and unlike others, meaning that it is impossible to find two identical fingerprints in two individuals. In comparison with the conventional identification system, a user does not need to remember different sets of account and password because his biometric features can now be his “password.” Furthermore, the biometrics technique is accurate and reliable. Although biometrics techniques have many advantages, they cannot directly replace the account-password framework of the conventional identification systems.

According to the above descriptions, under the current framework, a user has to remember different sets of account and password of different application softwares. Furthermore, when a user intends to use one of the application softwares, the user has to input the correct account and password. As a result, it is important to find a method to use the biometrics technique to replace remembering various sets of account and password, as well as a way to easily start an application.

### SUMMARY OF THE INVENTION

One objective of this invention is to provide a speech control apparatus for logging in an application software according to a speech signal of a user. The speech control apparatus is connected to a password bank stored a plurality of sets of account and password. The speech control apparatus comprises a speech process module, a start module, a first receiving module, an identity recognition module, a selection module, and a login module. The speech process module is configured to determine a meaning of the speech signal. The start module is configured to start the application software according to the meaning. The first receiving module is configured to receive a biometrics feature of the user. The identity recognition module is configured to identify the user as an authorized user according to the biometrics feature. The selection module is configured to select a login set of account and password from the password bank according to the meaning and the biometrics feature. The login module is configured to log into the application software according to the login set of account and password.

Another objective of this invention is to provide a speech control apparatus for logging into an application software according to a speech signal of a user. The speech control apparatus is connected to a password bank stored a plurality of sets of account and password. The speech control apparatus comprises a speech process module, a start module, an identity recognition module, a selection module, and a login module. The speech process module is configured to determine a meaning of the speech signal. The start module is configured to start the application software according to the meaning. The identity recognition module is configured to identify the user as an authorized user according to a voiceprint of the speech signal. The selection module is configured to select a login set of account and password from the password bank according to the meaning and the voiceprint. The login module is configured to log into the application software according to the login set of account and password.

Yet a further objective of this invention is to provide a speech control method for logging into an application according to a speech signal of a user. The method comprises the following steps: determining a meaning of the speech signal; starting the application software according to the meaning; receiving a biometrics feature from the user; identifying the user as authorized according to the biometrics feature; selecting a login set of account and password from a password bank according to the meaning and the biometrics feature; and logging into the application software according to the login set of account and password.

Another objective of this invention is to pro vide a speech control method for logging into an application software according to a speech signal of a user. The method comprises the following steps: determining a meaning of the speech signal; starting the application software according to the meaning; identifying the user as authorized according to a voiceprint of the speech signal; selecting a login set of account and password from a password bank according to the meaning and the voiceprint; and logging into the application software according to the login set of account and password.

The present invention uses a speech signal of a user to start the corresponding application, such as MSN or mail application software. After that, the account and password of the user are obtained from the password bank (the account and password can be different according to the application programs). Next, the account and password is used to log the user into the application. As a result, the present invention does not require a user to remember all the accounts and passwords and to manually input the accounts and passwords. It is noted that the application software in the present invention refers to the software, the application software, the system program, the Telnet service, and so on. Thus, MSN, Yahoo e-mail, etc. all fall within the scope of the application softwares mentioned in the present invention.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a schematic diagram of a first embodiment of the present invention;

FIG. 2 shows a schematic diagram of a second embodiment of the present invention;

FIG. 3 shows a flow chart of a third embodiment of the present invention; and

FIG. 4 shows a flow chart of a forth embodiment of the present invention.

### DESCRIPTION OF THE PREFERRED EMBODIMENT

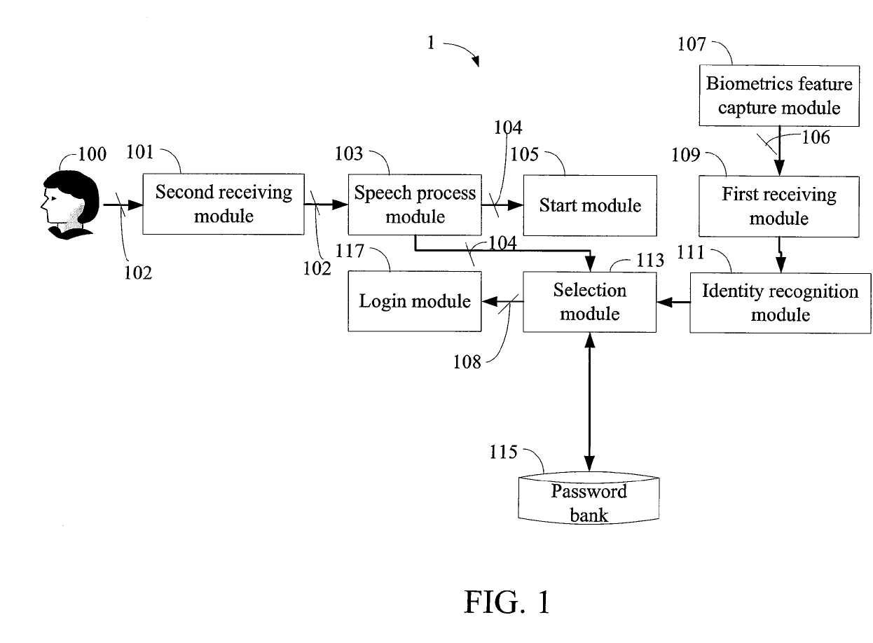

A first embodiment of the invention is shown in FIG. 1, which illustrates a speech control apparatus 1. The speech control apparatus 1 comprises a second receiving module 101, a speech process module 103, a start module 105, a biometrics feature capture module 107, a first receiving module 109, an identity recognition module 111, a selection module 113, and a login module 117. The speech control apparatus 1 is connected to a password bank 115 which stores a plurality of sets of account and password. Specifically, the password bank 115 of the first embodiment stores the sets of account and password for logging into the MSN software and the e-mail software. The password bank 115 also stores the registered fingerprints generated according to the fingerprint of an authorized user. The above descriptions are just examples and not intended to limit the scope of the invention. That is, the password bank 115 can store the sets of account and password for logging in other application software in other embodiments.

A user 100 speaks out a speech signal 102, such as “MSN.” It means that the speech signal 102 is “MSN.” The second receiving module 101 receives the speech signal 102. The speech process module 103 analyzes the speech signal 102 to determine a meaning 104. Specifically, the speech process module 103 analyzes the meaning carried in the speech signal 102 by a conventional technique, which is not detailed here. After the meaning 104 is determined, the start module 105 starts the application software corresponding to the meaning 104 (this means that MSN is started in the first embodiment). It is noted that at this time, the application software, MSN, has just started but the user has not logged in yet.

The first embodiment uses fingerprint recognition for security. As a result, the biometrics feature capture module 107 captures the biometrics feature of the user 100 for use as the biometrics feature 106, which is the fingerprint in this embodiment. The biometrics feature capture module 107 can be any device that can capture a fingerprint, such as a fingerprint sensor.

After that, the first receiving module 109 receives the biometrics feature 106 and transmits it to the identity recognition module 111. The identity recognition module 111 determines the user 100 as an authorized one according to the biometrics feature 106. Specifically, the identity recognition module 111 matches the biometrics feature 106 with the registered fingerprints stored in the password bank 115. The matching of the obtained biometrics feature with the stored biometrics feature is implemented according to a conventional technique.

After the identity recognition module 111 determines the user 100 as authorized, the selection module 113 selects a login set of account and password 108 according to the biometrics feature 106 and the meaning 104, which will be used to log in the started application software. Specifically, the selection module 113 selects all the sets of account and password of the user 100 from the password bank 115 according to the biometrics feature 106 and then selects the set of account and password specific to MSN as the login set of account and password 108. Alternatively, the selection module 113 can select all sets of account and password of MSN and then select the set of account and password specific to the user according to the biometrics feature 106 as the login set of account and password 108. After obtaining the login set of account and password 108, the login module 117 uses the login set of account and password to log in the started application.

It should be noted that the first embodiment can also be used to start other application softwares, such as an electronic email software, a text editing software, a computer game, etc. Moreover, the biometrics feature capture module 107 and the identity recognition module 111 can use other biometrics features, such as voiceprints, irises, human faces, palm prints, etc.

According to the above descriptions, the user can use the speech signal and the biometrics feature thereof to log in the application software rather than remembering multiple sets of account and password. The first embodiment provides a friendly operation environment.

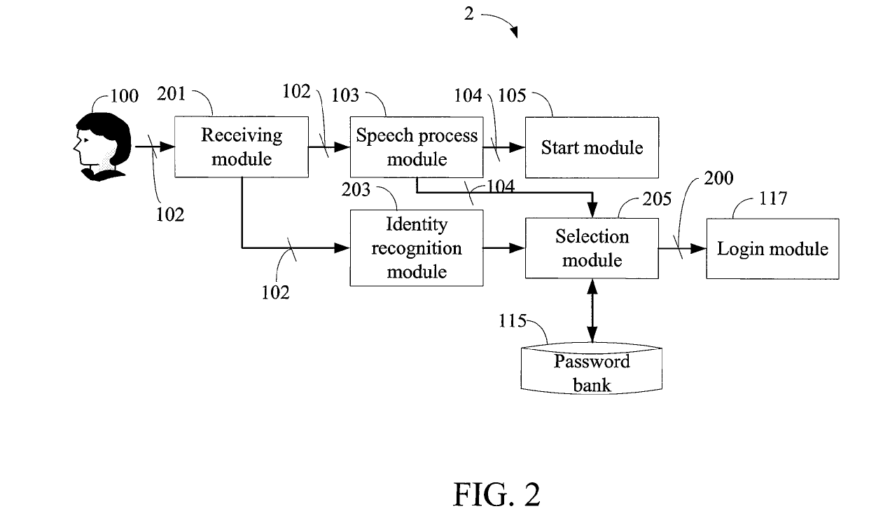

A second embodiment of the invention is shown in FIG. 2, which illustrates a speech control apparatus 2. The speech control apparatus 2 comprises a receiving module 201, a speech process module 203, a start module 205, an identity recognition module 211, a selection module 213, and a login module 217. The speech control apparatus 2 is connected to a password bank 215 which stores a plurality of sets of account and password and registered voiceprints according to the voiceprint of authorized users.

A user 200 speaks out a speech signal 202. The receiving module 201 then receives the speech signal 202. The speech process module 203 analyzes the speech signal 202 to determine the meaning 204 of the speech signal 202. The start module 205 is configured to start the application in response to the meaning 204.

The second embodiment uses voiceprint recognition for security, so the identity recognition module 211 determines the user 200 as an authorized one according to the voiceprint of the speech signal 202. Specifically, the identity recognition module 211 is implemented according to a conventional voiceprint recognition technique.

After the identity recognition module 211 determines the user 200 as an authorized one, the selection module 213 selects a login set of account and password 208 to log into the started application from the password bank 215 according to the meaning 204 of the speech signal 202. Thereafter, the login module 217 logs in the started application software according to the login set of account and password 208.

The difference between the first and the second embodiment is that the identity recognition module 211 of the second embodiment directly recognizes the speech signal 202 of the user 200. It does not require a biometrics feature capture module for biometrics feature capture. Hence, the second embodiment requires fewer hardware resources to automatically log into the application.

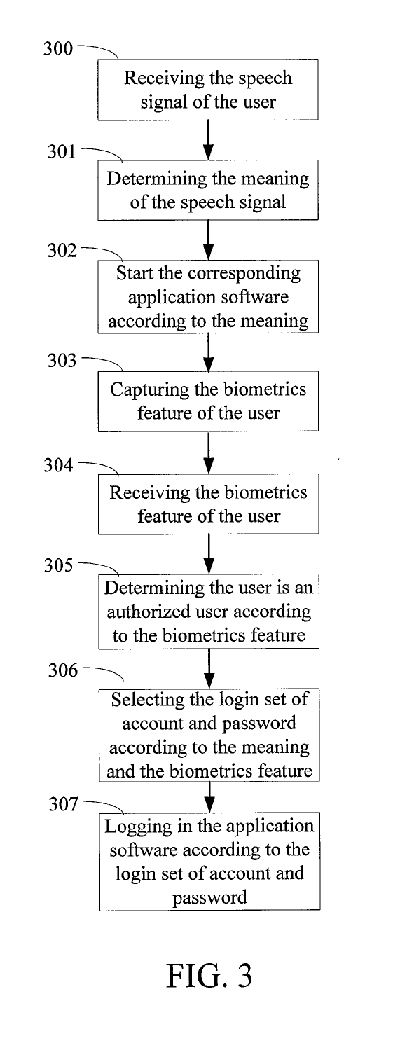

A third embodiment of the invention is shown in FIG. 3, which illustrates a flow chart of the speech control method. First, step 300 is executed to receive a speech signal of a user. For example, if the user says “MSN”, the speech signal received in step 300 would be “MSN.” After that, step 301 is executed to determine a meaning of the speech signal (i.e. analyzing the meaning which the user expresses in the speech signal). Then, step 302 is executed to start the corresponding application according to the meaning of the speech signal (i.e. the application software “MSN”). It is noted that at this time, the application software MSN has just been started but has not been logged in yet. Thus, the application software MSN cannot be used yet.

Assume that the third embodiment uses fingerprint recognition for security. Step 303 is executed to capture a biometrics feature of the user (i.e. a fingerprint). Then, step 304 is executed to receive the biometrics feature of the user. Step 305 is then executed to determine whether the user is authorized according to the biometrics feature. If not, step 303 attempts to capture the biometrics feature of the user again. If so, step 306 is executed to select a set of account and password from the password bank as a login set of account and password. Specifically, the password bank stores a plurality of sets of account and password for different applications and different users. Consequently, step 306 selects the login set of account and password from the password bank for logging in the application software (i.e. MSN) according to the biometrics feature (to find the correct user) and the meaning of the speech signal (to find the correct application software). Finally, step 307 is executed to log in the application according to the login set of account and password.

Aside from the steps drawn in FIG. 3, the third embodiment can also execute all operations and functions of the first embodiment. People skilled in this field can understand how the third embodiment executes the operations and functions based on the first embodiment. The details are not repeated here.

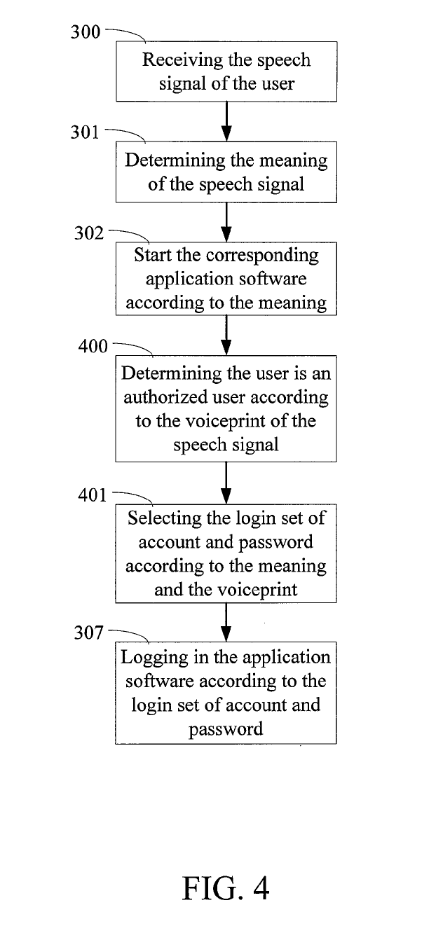

A fourth embodiment of the invention is shown in FIG. 4, which illustrates is a flow chart of a speech control method. The third and forth embodiments are identical, except for the differences described hereafter. First, step 300 is executed to receive a speech signal of a user. Next, step 301 is executed to determine a meaning of the speech signal. Step 302 is then executed to start the corresponding application according to the meaning.

After that, step 400 is executed to determine whether the user is authorized according to a voiceprint of the speech signal, wherein step 400 can be realized by a conventional voiceprint recognition technique. If not, step 300 attempts to obtain the speech signal of the user again. If so, step 401 is executed to select the login set of account and password stored in the password bank according to the voiceprint and the meaning of the speech signal. To be more specific, step 401 uses the voiceprint select sets of account and password corresponding to the correct user and uses the meaning to find the set of account and password corresponding to the correct application software. Finally, step 307 is executed to log the user in the application software according to the login set of account and password.

Aside from the steps drawn in FIG. 4, the fourth embodiment can also execute all operations and functions of the second embodiment. People skilled in this field can understand how the forth embodiment executes the operations and functions based on the second embodiment. The details are not repeated here.

According to the above descriptions, the speech signal of the user can be used to start the desired application, such as MSN application software, electronic mail application software, etc. After starting the application software, the present invention can select a set of account and password from the password bank according to the biometrics feature of the user and then logs in the started application software according to the selected set of account and password. Hence, the apparatus and method of the present invention can effectively avoid the inconvenience of having to remember many sets of account and password and manually inputting those sets of account and password.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A speech control apparatus for logging in an application software according to a speech signal of a user, the speech control apparatus being connected to a password bank stored a plurality of sets of account and password, the speech control apparatus comprising:
a speech process module for determining a meaning of the speech signal;
a start module for starting the application software according to the meaning;
a first receiving module for receiving a biometrics feature of the user;
an identity recognition module for identifying the user as an authorized user according to the biometrics feature;
a selection module for selecting a login set of account and password from the sets of account and password according to the meaning and the biometrics feature; and
a login module for logging in the application software according to the login set of account and password.

2. The speech control apparatus of claim 1, further comprising:
a biometrics feature capture module for capturing the biometrics feature.

3. The speech control apparatus of claim 1, further comprising:
a second receiving module for receiving the speech signal of the user.

4. The speech control apparatus of claim 1, wherein the biometrics feature comprises one of a fingerprint, a voiceprint, an iris, a human face, a palm print, and a combination thereof.

5. The speech control apparatus of claim 1, wherein the application software comprises one of an electronic mail software, an instant message software, a text editing software, and a computer game.

6. A speech control apparatus for logging in an application software according to a speech signal of a user, the speech control apparatus being connected to a password bank stored a plurality of sets of account and password, the speech control apparatus comprising:
a speech process module for determining a meaning of the speech signal;
a start module for starting the application software according to the meaning;
an identity recognition module for identifying the user as an authorized user according to a voiceprint of the speech signal;
a selection module for selecting a login set of account and password from the sets of account and password according to the meaning and the voiceprint; and
a login module for logging in the application software according to the login set of account and password.

7. The speech control apparatus of claim 6, further comprising:
a receiving module for receiving the speech signal of the user.

8. The speech control apparatus of claim 6, wherein the application software comprises one of an electronic mail software, an instant message software, a test editing software, and a computer game.

9. A speech control method for logging in an application software according to a speech signal of a user, comprising the steps of:
determining a meaning of the speech signal;
starting the application software according to the meaning;
receiving a biometrics feature from the user;
identifying the user being authorized according to the biometrics feature;
selecting a login set of account and password from a password bank stored a plurality of sets of account and password according to the meaning and the biometrics feature; and
logging in the application software according to the login set of account and password.

10. The speech control method of claim 9, further comprising the step of capturing the biometrics feature.

11. The speech control method of claim 9, further comprising the step of receiving the speech signal of the user.

12. The speech control method of claim 11, wherein the biometrics feature comprises one of a fingerprint, a voiceprint, an iris, a human face, a palm print, and a combination thereof.

13. The speech control method of claim 11, wherein the application software comprises one of an electronic mail software, an instant message software, a text editing software, and a computer game.

14. A speech control method for logging in an application software according to a speech signal of a user, comprising the steps of:
determining a meaning of the speech signal;
starting the application software according to the meaning;
identifying the user being authorized according to a voiceprint of the speech signal;
selecting a login set of account and password from a password bank stored a plurality of sets of account and password according to the meaning and the voiceprint; and
logging in the application software according to the login set of account and password.

15. The speech control method of claim 14, further comprising the step of receiving the speech signal of the user.

16. The speech control method of claim 14, wherein the application software comprises one of an electronic mail software, an instant message software, a text editing software, and a computer game.
